(19) United States
(12) Patent Application Publication
(10) Pub. No.: US 2004/0205612 A1
(43) Pub. Date: Oct. 14, 2004

(54) Programmatically generating a presentation style for legacy host data

(75) Inventors: Julie H. King, Raleigh, NC (US); Susan D. Kirkman, Cary, NC (US); Steven W. Pogue, Cary, NC (US)

Correspondence Address: Jeanine S. Ray-Yarletts, IBM Corporation T81/503, P.O. Box 12195, Research Triangle Park, NC, 27709, US

(73) Assignee: International Business Machines Corporation, Armonk, NY (US)

(21) Appl. No.: 10/120,035

(22) Filed: Apr. 10, 2002

(51) Int. Cl. G06F 17/24

(52) U.S. Cl. 715/522

(57) ABSTRACT

Methods, systems, and computer program products for programmatically generating presentation style information for use when subsequently rendering a collection of legacy host data values. In preferred embodiments, the style information is a style sheet document, and the generation is based upon values stored in a prior art map that is defined for used when displaying the collection of legacy host data values. Improvements are therefore provided in the user interface techniques which allow users to interact with legacy host applications. The generated presentation style information may be treated as a default presentation style, and may be modified (for example, by a user) for a more customized presentation style. The programmatic generation may be performed in a tool created specifically for this purpose, or in logic which augments an existing tool (such as a style sheet editor).

### BACKGROUND OF THE INVENTION

1. Field of the Invention

The present invention relates to computer systems, and deals more particularly with methods, systems, and computer program products for programmatically generating presentation style information (such as a style sheet document) for use when subsequently rendering a collection of legacy host data values.

2. Description of the Related Art

Prior to the advent of graphical user interfaces and window-oriented visual presentation models, application programs were typically written to interact with display terminals which were adapted for displaying and accepting data using a fixed grid or matrix of column and row positions for data values. Historically, these terminals displayed only letters, number, and a few special characters and limited graphics, and supported a very limited set of visual presentation attributes. For example, data displayed on these character-based terminals typically used either a green or white font on a black background screen, with the capability for overriding this presentation style in very limited ways (for example, to use highlighting techniques such as reverse video or underlining for particular column and row positions).

By the 1980s, however, these character-based terminals were being replaced with “intelligent” workstations that used graphical user interfaces and windowing presentation models for interacting with users. Today, the character-based terminals have become virtually obsolete.

Vast numbers of computer programs were written for use with the character-based terminals. Computer programs of this type are commonly referred to as “legacy host” applications or simply “legacy” applications. Literally millions of lines of legacy host application code remain in use throughout the world. One of the challenges facing information services professionals today is the difficulty of integrating these legacy host applications and their data with modern computing environments and their modern user interfaces. In particular, it is necessary to extend the reach of many legacy host applications such that they can be accessed through the Internet and in World Wide Web-enabled environments for business-to-business (“B2B”) and business-to-consumer (“B2C”) use. (The term “Web” is used hereinafter to refer to the World Wide Web as well as the Internet, for ease of reference.)

Most legacy host applications were written with the character-based terminal presentation space as the only interface format in which the host data output is created, and in which host data input is expected. (“Presentation space” is a term used abstractly to refer to the collection of information that together comprises the information to be displayed on a user interface screen plus the control data that conveys how and where that information is to be represented.)

A typical character-based terminal is the IBM Model 327x from the International Business Machines Corporation (“IBM”). This terminal model was designed to display (and accept) information using a matrix of characters that typically consisted of 24 rows each having 80 columns. For applications that were written expecting this display format, programmers specified placement of information on the screen using specific row and column locations. Historically, information formatted for this display model was then sent from the legacy host application as a data stream to the mechanism in the display hardware that is responsible for actually displaying the screen contents. The phrase “data stream” refers to the fact that the data is sent as a linear string, or stream, of characters. This stream of characters contains both the actual textual information to be displayed on the screen as well as information specifying where and how the text is to be displayed. “Where” consists of the row and column where the text is to begin, and “how” consists of a limited number of presentation attributes such as what color (typically either green or white) to use when displaying that text, whether a field is protected (i.e. input-inhibited), limited types of special presentation attributes (such as reverse video and underlining), etc., as has been discussed earlier.

While the Model 327x is a specific type of IBM display hardware, data formatted for any display having similar characteristics became a de facto standard format referred to as a “3270 data stream”. Similarly, the IBM Model 525x is another type of character-based terminal. This terminal displays data in a slightly different manner from the IBM 327x, and consequently uses a different data stream format. The “5250 data stream” also became a de facto standard format for displays having similar characteristics. A third type of data stream format commonly used by legacy host applications is referred to simply as an “ASCII data stream” (or equivalently as a Virtual Terminal, or “VT”, data stream). While an ASCII data stream is not formatted for a specific model of display screen, a data stream in this format has certain predefined characteristics (for example, the manner in which a control character indicates the line spacing to be used).

Hereinafter, the terms “3270 data stream” and “legacy host data stream” are used synonymously to refer to these various types of character-based data streams.

The displays used with modern computer workstations (including personal computers, handheld computing devices, network computers, so-called “smart” appliances in the home, and other types of computing devices) support graphics and video, in addition to text characters. These displays do not use a character-based row and column matrix approach to screen layout. Instead, an application program in this environment has access to thousands of tiny display elements, allowing the various types of information to be placed virtually anywhere on the display screen.

When a modern computer workstation is used to access a legacy host application running on a mainframe or a server, the output data created by that host application is often still formatted as one of the character-based data stream formats. It is therefore necessary to somehow adapt the character-based data sent by the legacy application (using the presentation space for transferring data) for display on a modern display screen. This problem has been recognized for a number of years, and consequently, a number of products and techniques have been developed.

One way to adapt legacy host data for a modern display screen is to rewrite the legacy application. However, this is typically not a viable approach for a number of reasons. As one example, the supply of programmers having the required programming skills is quite limited. As another example, a considerable time and expense would be involved with rewriting, re-testing, and re-deploying the huge installed code base. As yet another example, it is often the case that the legacy source code is no longer available and thus cannot be used for guiding a redesign and rewriting project.

In an alternative approach that is commonly used, legacy host data is adapted for a modem display through a process known as “screen scraping”. Screen scraping is performed by providing a user interface facility that accepts the existing host presentation space format when retrieving data from the host application, but does not show the data to the user in this format. Instead, the user interface facility “scrapes” (that is, extracts) data from the host presentation space, reformats it (typically in an application-specific manner), and presents it to the user in a form that is appropriate for the display screen device used with the workstation. By convention, this form tends to be a graphical user interface (“GUI”) where information is presented in a window-based layout. The user then interacts with the application using this graphical user interface.

Commonly-assigned U.S. Pat. No. ______ (Ser. No. 09/754,987, filed Jan. 05, 2001), which is entitled “Technique and Tools for High-Level Rule-Based Customizable Data Extraction”, discloses techniques for extracting data from a data stream (including data streams that contain the presentation space for a legacy host screen) using a rule-based approach that does not require a user to write programming language statements. This patent also describes several other existing approaches for integrating legacy applications into the Web environment. Refer to this U.S. patent for more details on the advantages and disadvantages of these various approaches. Briefly, the approaches described therein include:

Writing code to extract data values from the presentation space. Examples of this approach include using the Host Access Class Library (“HACL”) product from IBM, which provides programming access to 327x, 525x, and Virtual Terminal data streams using an object-oriented interface.

Use of software products for extracting strings and/or fields of information from the presentation space, where these products record macros for interacting with the presentation space data. Examples of this type of products include IBM's Host On-Demand and Screen Customizer products.

Extraction of data from the presentation space using a knowledge base and/or a rules-driven approach.

Component extraction using hard-coded heuristics. Commonly-assigned U.S. Pat. No. ______ (Ser. No. 09/353,218, filed Jul. 14, 1999), which is titled “Methods, Systems, and Computer Program Products For Applying Styles to Host Screens Based on Host Screen Content”, which is hereby incorporated herein by reference, discloses a technique for generating high-level complex data components in an extensible format by simple selection.

For the foreseeable future, legacy host applications will continue to be widely used. The Customer Information Control System product from IBM, commonly known as “CICS®”, is an example of a legacy host application platform that continues to thrive in modern computing environments. Recent estimates are that more than 30 billion transactions are performed each business day using CICS applications, representing the daily transfer of $1 trillion. (“CICS” is a registered trademark of IBM.) The IMS™ program product from IBM is another widely-deployed legacy platform. IMS provides a transaction and hierarchical database management system, and IMS applications are used in many different fields today. (“IMS” is a trademark of IBM.)

Therefore, what is needed are improvements in the user interface techniques which allow users to interact with these legacy host applications.

### SUMMARY OF THE INVENTION

An object of the present invention is to provide improvements in the user interface techniques which allow users to interact with these legacy host applications.

Another object of the present invention is to provide these improvements by programmatically generating a presentation style (such as a style sheet document) for use when subsequently rendering a collection of legacy host data values.

A further object of the present invention is to provide these improvements wherein presentation attributes are programmatically extracted from maps that are defined for use when rendering legacy host data values.

Yet another object of the present invention is to provide these improvements wherein the generated presentation style information provides a default presentation style, which may be easily modified (for example, by a user) for a more customized presentation style.

Still another object of the present invention is to provide the programmatic generation within a tool used to edit presentation style information.

Other objects and advantages of the present invention will be set forth in part in the description and in the drawings which follow and, in part, will be obvious from the description or may be learned by practice of the invention.

To achieve the foregoing objects, and in accordance with the purpose of the invention as broadly described herein, the present invention provides a method, system, and computer program product for programmatically generating a presentation style for legacy host data. In preferred embodiments, this technique comprises: identifying a mapping associated with a particular legacy host screen, where the identified mapping stores presentation style information for the particular legacy host screen; programmatically extracting the stored presentation style information from the identified mapping; programmatically formatting the extracted presentation style information as style information for the particular legacy host screen; and storing the style information for the particular legacy host screen in a repository.

The technique may further comprise: obtaining a set of data values for the particular legacy host screen, along with an identification of the mapping associated with the particular legacy host screen; retrieving the stored style information from the repository using the identification of the mapping; and programmatically creating a rendering of the particular legacy host screen by applying the retrieved style to the obtained set of data values.

The style information may be programmatically formatted as elements of a style sheet, or in another form such as rules in a rules base. Preferably, the style sheet is an Extensible Stylesheet Language (“XSL”) style sheet. The style sheet may be a default style sheet, in which case the technique may further comprise modifying one or more of the elements of this default style sheet and/or adding one or more elements to the default style sheet. The modifications and/or additions may tailor the style sheet for a particular target device, a particular recipient, and so forth. The modifications and/or additions might be designed to improve usability of the rendering.

The present invention will now be described with reference to the following drawings, in which like reference numbers denote the same element throughout.

### BRIEF DESCRIPTION OF THE DRAWINGS

FIG. 1 illustrates a character-based user interface display of the prior art;

FIGS. 2A and 2B illustrate prior art approaches to exchanging data between a client and legacy host, and FIG. 2C shows an exchange configuration which may be used with preferred embodiments of the present invention;

FIG. 3 provides an example of a map segment which is used by prior art techniques to display legacy host data values;

FIG. 4 illustrates an example of syntax from a structured markup language document which transmits legacy host data values and which identifies its associated map;

FIG. 5 provides a high-level illustration of how preferred embodiments of the present invention operate to create presentation style information, and FIG. 6 provides a flowchart depicting logic which may be used in this programmatic generation process;

FIG. 7 (comprising FIGS. 7A-7C) shows an example of a style sheet generated according to the techniques disclosed herein to specify a default presentation style;

FIG. 8 depicts how the generated presentation style information is fetched at run-time and applied to a collection of legacy host data values;

FIG. 9 illustrates how the programmatic generation techniques of the present invention may be incorporated within a style sheet editor; and

FIG. 10 depicts an overall flow of execution that may occur when using the present invention.

### DESCRIPTION OF PREFERRED EMBODIMENTS

A number of techniques are in use today for dealing with legacy host data in modern computing environments, several of which have been discussed. The present invention defines improvements to the state of the art in this area. Preferred embodiments will be described herein with reference to improvements directed toward CICS applications and their data. However, this is for purposes of illustration and not of limitation. The disclosed techniques may be used advantageously with other types of applications and data without deviating from the scope of the present invention. For example, the techniques disclosed herein may be used to improve user interactions with IMS applications, which were discussed earlier.

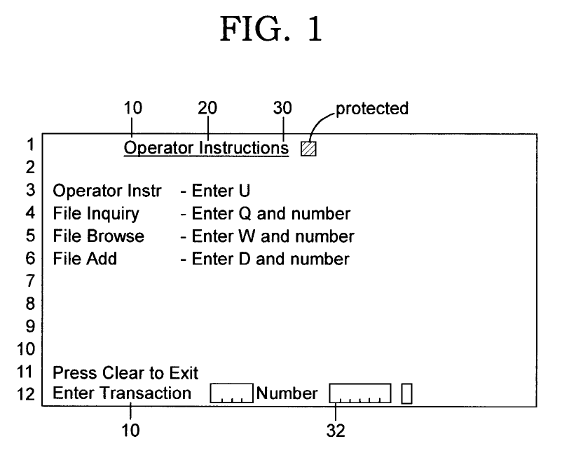

FIG. 1 illustrates a character-based user interface display of the prior art. This example shows the grid or matrix layout where the displayed characters appear in fixed row and column positions of the display screen. In this example, the display screen communicates operator instructions, and allows the user to enter one of several letter codes and/or a transaction number. The information entered by the user must also come from a particular fixed row and column. This type of display is sometimes referred to as a “green screen”, in reference to use of green for displayed characters.

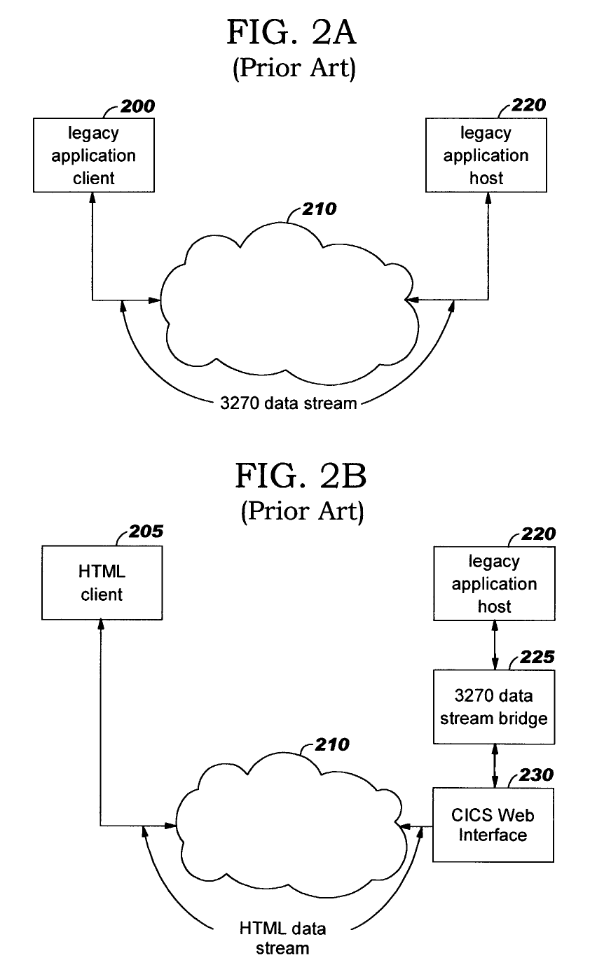

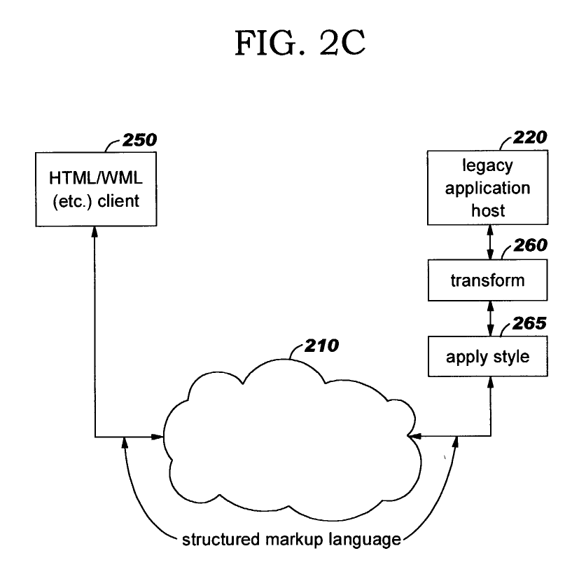

FIG. 2A shows a configuration commonly used by legacy applications of the prior art for communicating between a client computer and a host computer. As shown therein, the legacy client 200 and legacy host 220 exchange data over a communications network 210 using a 3270 data stream. As stated earlier, this data stream includes characters to be displayed as well as presentation style information to be used when creating the display. For example, the data stream might specify information used in generating the display screen shown in FIG. 1. However, as was discussed earlier, when the data stream is sent to a computer workstation having a modetn display, some type of conversion must be performed in order to render the information.

FIG. 2B illustrates another prior art approach to exchanging data between a client 205 and legacy host 220. In this example configuration, the legacy client 200 from FIG. 2A has been replaced with a modern HTML client (e.g. a browser), and the data stream transmitted through the network is now an HTML data stream. A software component referred to as “3270 data stream bridge” 225 is placed on the outbound side of the legacy host. This bridge software converts the 3270 data stream to an Extensible Markup Language (“XML”) document, and that XML document is then sent to a component referred to in FIG. 2B as “CICS web interface” 230, which converts the XML document to an HTML document before transmitting that data over communications network 210. The 3270 bridge and CICS web interface are products of IBM, and will now be briefly described. (For detailed information on these products, which do not form part of the inventive concepts of the present invention, contact an IBM sales branch office or refer to location http://www.ibm.com on the Internet.)

The “3270 bridge” feature is used today by large numbers of existing CICS applications in the manner shown in FIG. 2B. This bridge allows the data which would flow via a 3270 session in the prior art to be handed to another application in a more modern data format, and in particular, as an XML document. XML is a structured markup language that is commonly as a modern interchange notation for communicating between devices in today's networking environments. Converting between the legacy data stream used by a legacy host application and a more modern interchange notations such as XML allows legacy host applications to interact with modern clients installed on modern computing devices. A “BMS map” identifier, which defines the original presentation layout for that data, is included as one of the data elements in the XML document. “BMS” is an acronym for “Basic Mapping Services”, and refers to a CICS service with which display screen layouts can be created. A BMS map identifier (“ID”) is a code that identifies a particular one of these screen layouts. Transmitting the BMS map ID along with the data to be displayed on the screen allows the delivery of the CICS information and its presentation using a non-3270 format. For example, these messages may be delivered using the HyperText Transfer Protocol, commonly referred to as “HTTP”, when connecting to CICS through the CICS Web Interface 230 with the 3270 bridge feature.

However, in the prior art process shown in FIG. 2B, it is not possible to modify the output screens or to create a new style or output format (i.e. the original “green screen” look and feel is presented).

In FIG. 2C, a configuration used by preferred embodiments of the present invention for exchanging information between a modern client 250 and legacy host 220 is depicted. In this configuration, the client is no longer limited to using HTML, and is therefore shown as an HTML client or Wireless Markup Language (“WML”) client or other type of client. As shown in the figure, a transformation of the legacy data stream is performed by a software component referred to in FIG. 2C as “transform” 260. This component represents a transformation of the legacy data stream to a form where the data values are encoded in a modern notation (which is preferably XML) and the BMS map identification is provided. Furthermore, according to the techniques disclosed herein, a style sheet corresponding to the BMS map is programmatically generated, and is applied as shown at 265 in FIG. 2C. The resulting data stream which is transmitted to the client 250 then contains style information (such as colors, underlining, and so forth) which may either reflect the original legacy host screen or improvements thereto, as desired in a particular implementation of the present invention.

Exchanging data between devices in the manner shown in FIG. 2B facilitates a business-to-business (“B2B”) type of access for application programs. However, for a business-to-consumer (“B2C”) environment (i.e. application programs which involve user input from a display screen), this solution leaves room for improvement. Even though the application data is transmitted, and can be rendered for the HTML client 205 using a modern display, it would be preferable to make beneficial use of the presentation information defined in the historical BMS maps. The present invention solves this problem. Furthermore, the present invention enables programmatically transforming the data, if desired (for example, into alternative markup languages, or by “styling” the data, or perhaps by transforming data values using style sheet rules), which may be advantageous in B2B environments as well as for B2C use.

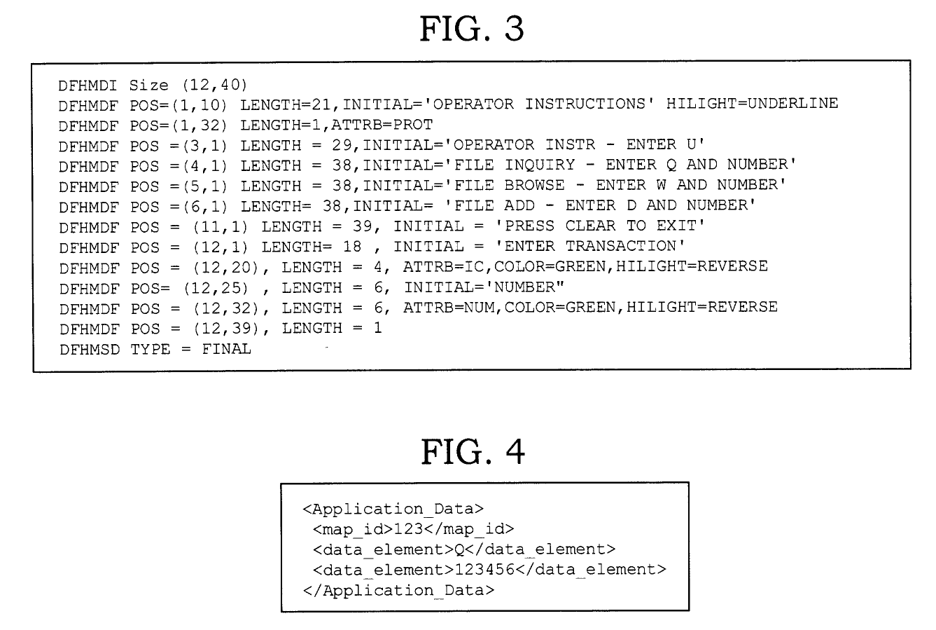

Referring now to FIG. 3, an example segment from a BMS map is provided. This map segment is representative of a BMS map which is used by prior art techniques to display legacy host data values. As can be seen by inspection, the map specifies row and column number positions for various text strings, indicating where those text strings should appear on a character-based terminal display screen. Several types of attribute information are also encoded in the map. For example, the syntax “HILIGHT=UNDERLINE” indicates that the string “OPERATOR INSTRUCTIONS”, when displayed starting from column 10 of row 1, should be highlighted by underlining. The syntax “ATTRB=PROT” indicates that the 1-character field in row 1, column 32 should be a protected (i.e. input-inhibited) field. The syntax “ATTRB=IC,COLOR=GREEN, HILIGHT=REVERSE” indicates that the 4-character field which begins at column 20 of row 12 should be displayed in reverse video, using green. Similarly, the syntax “ATTRB=NUM, COLOR=GREEN,HILIGHT=REVERSE” indicates that the 6-character field beginning in column 32 of row 12 should be displayed in reverse video, using green. (As will be obvious, the example syntax used in FIG. 3 is merely one form of syntax that may be used for specifying screen layout and presentation information for legacy host screens, and thus this example is provided for purposes of illustration but not of limitation.)

Referring again to FIG. 1, the display screen shown therein represents the information specified in the BMS map of FIG. 3. (For ease of illustration, the reverse video attributes have not been reflected in FIG. 1.)

FIG. 4 illustrates an example of syntax from a structured markup language document which transmits legacy host data values and which identifies its associated map. In this example, the map ID is carried in a “map_id” element, and several “data_element” elements are used to carry data pertaining to the legacy host application program. (As will be obvious, element names may vary widely from one application to another, and thus a generic name “data_element” has been used in the example.) For purposes of the discussion herein, it should be assumed that the value of the map_id element, “123”, identifies a map containing the map segment in FIG. 3. The style sheet that is programmatically created for the map in FIG. 3 is then associated with the map_id value of “123” (see the discussion of Block 660 of FIG. 6, below), so that this style sheet can be located at run time and applied by the style sheet engine for to the data values associated with the map.

The sample document in FIG. 4 also illustrates how data values representing a legacy host application's output may be encoded in an XML document. In this example, the sample document contains the value “Q” for the first data element, and the value “123456” for the second data element. These values correspond to the map in FIG. 3 (and the sample display screen in FIG. 1), where the value “Q” indicates a query (i.e. “file inquiry”) transaction and the value “123456” provides the 6-digit transaction number.

The present invention defines techniques for processing information stored in a map (which is referred to herein as a BMS map, for ease of reference), and programmatically generates presentation style information to be used when subsequently rendering data values. In preferred embodiments, the presentation style information is generated as an XSL style sheet, and specifies a default mapping. (References herein to XSL style sheets are by way of illustration, but not of limitation. The presentation style information may be encoded using other notations, without deviating from the scope of the present invention.) When the generated style sheet is later applied to a collection of data values, the result will be to display the data values similar to the way a legacy 3270 terminal would have presented the data values. Optionally, the generated style sheet may be opened with a tool such as a style sheet editor, where it can be transformed in various ways. For example, usability modifications might be made, such that applying the style sheet will result in an easier-to-use GUI. Or, the style sheet might be modified such that it will generate displays appropriate for particular environments and/or devices (e.g. for use in web environments, or by pervasive computing devices such as handheld computers). Examples of this type of modification include changing the markup language in which the output document is rendered from HTML to another notation such as WML or the Wireless Application Protocol (“WAP”). As a further option, the programmatic generation process may be incorporated within an augmented style sheet editor, whereby the editing process may then be preceded by the programmatic generation of the style sheet from the BMS map.

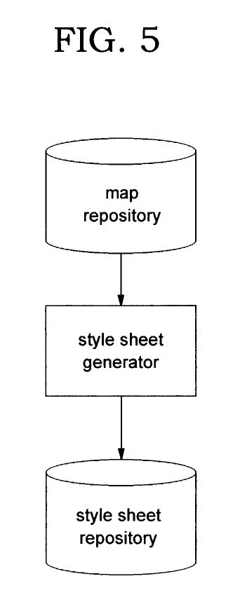

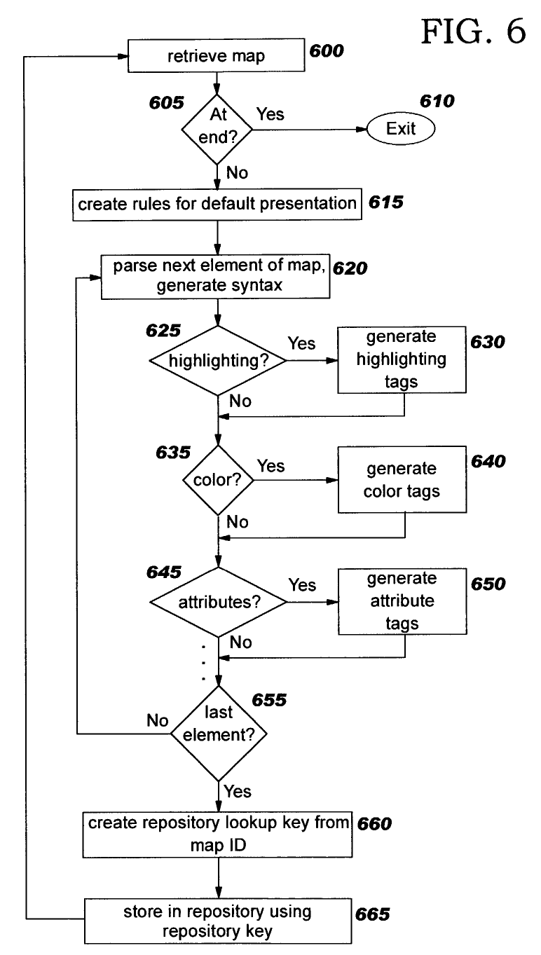

FIG. 5 provides a high-level illustration of how preferred embodiments of the present invention operate to create presentation style information. As shown therein, one or more maps from a map repository are processed by the style sheet generator of the present invention, with the resulting style sheet(s) being stored in a style sheet repository.

The flowchart in FIG. 6 depicts logic which may be used by preferred embodiments of the present invention for programmatically generating a style sheet from a BMS map. As shown therein, the process begins (Block 600) by retrieving a map from a map repository. Block 605 checks to see if the last map has already been processed. If so, then the processing of FIG. 6 ends (Block 610); otherwise, processing continues at Block 615.

Block 615 generates style sheet syntax to represent common (i.e. non-map-specific) information. This common information includes the basic structure of the style sheet, such as the headers and definition statements.

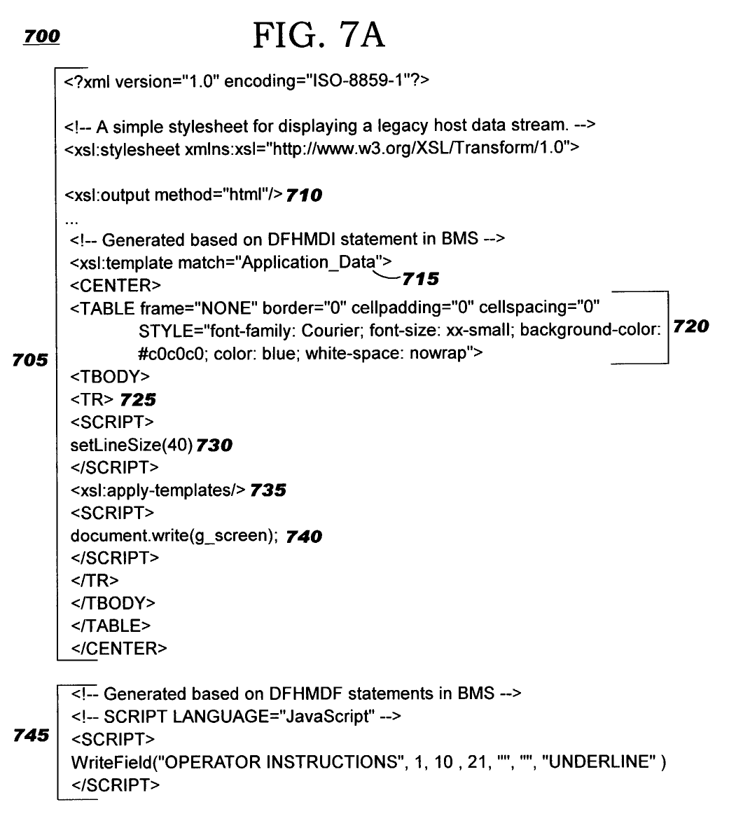

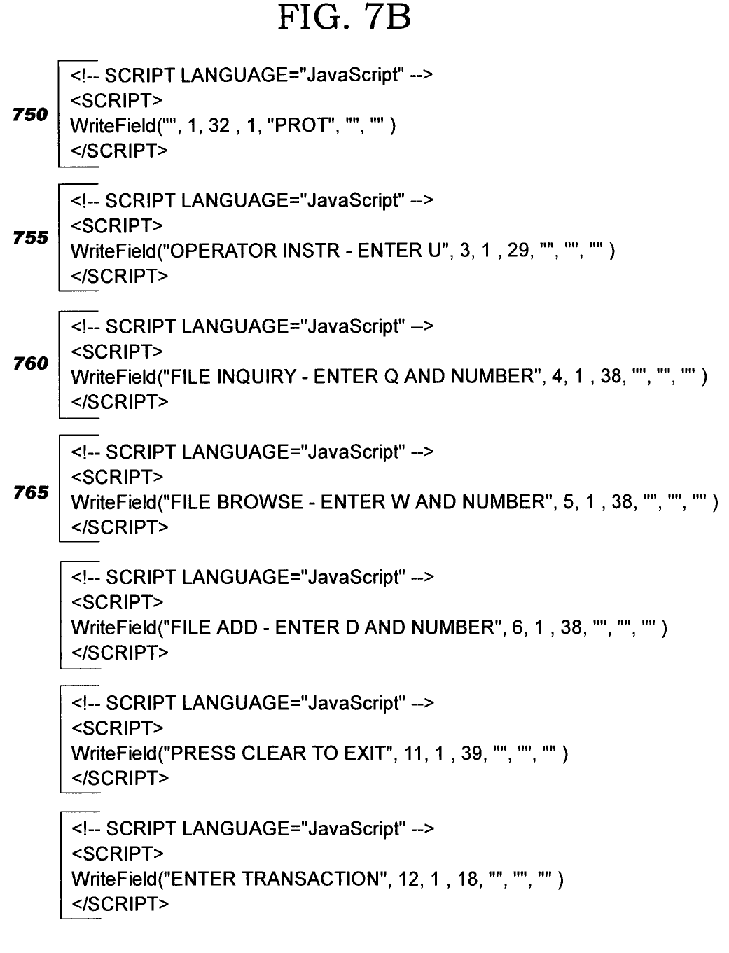

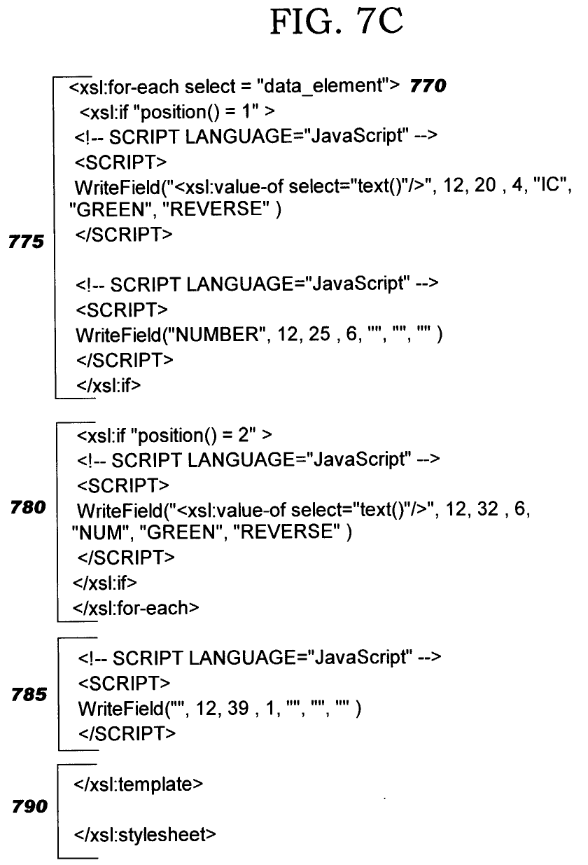

Refer to the example style sheet in FIG. 7 (comprising FIGS. 7A-7C), which is used to illustrate the programmatic generation techniques disclosed herein. The syntax shown at elements 705 and 790 represents the common information generated at Block 615. In this example, the common information includes a specification of the output method as being the HyperText Markup Language (“HTML”), as shown at 710, and a template rule for rendering a table (see element 720) upon detecting the characters “Application_Data” in the input XML file (see element 715). A set of attributes for this table are specified at element 720, by way of illustration, including the font to be used within that table, the font size, color, and so forth. The body of this table is specified as having one row (see element 725). Within this row, syntax is generated to invoke a scripting language (such as JavaScript). In the example, the scripting language is first invoked to set the line length to 40 (see element 730), and then XSL syntax is used to cause other rules in the style sheet to be evaluated (see element 735). After the rules have been evaluated, the display screen will have been generated, and thus another scripting language invocation is specified (see element 740) to cause the screen to be displayed.

Generating the style sheet to be augmented with Javascript is optional, and is used in preferred embodiments to facilitate XSL editing. The Javascript functions “setLineSize”, “document.write”, and “WriteField” (see elements 730, 740, and 745, etc.) are responsible for building the actual HTML table cell tags given the parameters which are passed. In the example, the parameters to be passed are (text, row, column, length, attribute, color, highlight), as will be described with reference to elements 745-785. Alternatively, an embodiment of the present invention may choose to generate all the HTML inline or to use other techniques such as JavaServer Pages™ (“JSP™”) tags in a servlet to render the fields. (“JavaServer Pages” and “JSP” are trademarks of Sun Microsystems, Inc.)

An understanding of the schema according to which the XML documents that transmit legacy host data values will be created, along with an understanding of allowable BMS map syntax, is applied during the process of generating each particular style sheet. The characters “Application_Data” 715 are generated automatically, where these characters enable matching the style sheet rule which begins at 715 to an XML document. (See the example document in FIG. 4, which uses an <Application_Data> tag to bracket elements containing the map identifier and a collection of data values.)

The value to be used for setting the line length is preferably extracted from the map being processed. See, for example, the first entry in the map segment in FIG. 3, specifying 12 rows and 40 columns. The remaining syntax in elements 705 and 790 is preferably generated for all maps. A particular enterprise implementing the present invention may choose to specify this common information differently. For example, different values may be specified for the style attributes of the TABLE tag 720, etc. In this manner, the enterprise may customize its display screens, for example by putting its preferred colors/fonts/images on its display screen definitions.

Referring again to FIG. 6, at Block 620, the next element of the BMS map is parsed, and corresponding syntax is generated in the style sheet. Blocks 625-650 represent comparisons that may be made while processing the parsed element. In Block 625, a test is made to see if this element specified highlighting information. If so, then Block 630 generates tag syntax to represent the specified highlighting within the XSL style sheet. Block 635 tests to see if this element specified color information. If so, then Block 640 generates tag syntax to represent the specified color within the XSL style sheet. Block 645 tests to see if the element specified attribute information. If so, then Block 650 generates tag syntax to represent the specified attribute within the XSL style sheet.

Examples of results of the processing of Blocks 620-650 are shown in FIG. 7. Upon encountering the first “POS” row of the input map, which specifies a text string that is to be underlined, a corresponding entry 745 is generated in the style sheet. The style sheet syntax will evaluate directly the generated statements from the BMS map until the point in which data is to be injected (see element 770), and will cause the text strings from the map to be written by invoking the “WriteField” function. As stated earlier, the parameters passed to this function in the example are (text, row, column, length, attribute, color, highlight). Thus, the text string “OPERATOR INSTRUCTIONS” from the BMS map entry is generated as the first parameter value, and its highlighting value is generated as the seventh parameter value. The row, column, and length values are copied from the BMS map entry to become the second through fourth parameter values, and since there are no attribute values or color values on the entry, the fifth and sixth parameter values are left empty.

The second “POS” row of the input map specifies a 1-character protected field. Thus, when generating the corresponding style sheet syntax shown at 750, the text string parameter value is left empty, as are the color and highlighting values. The row, column, and length values are copied from the BMS map entry, and the attribute value “PROT” is copied as the value of the fifth parameter. Elements 755, 760, and 765 in FIG. 7B show how the third, fourth, and fifth “POS” rows of the input map are generated, having empty values for the final three parameters. The next several statements in the XSL style sheet syntax of FIG. 7B are analogous to those which have been described.

In elements 775 and 780, “xsl:if” statements are programmatically generated within the scope of an “xsl:for-each” tag 770 that has been generated to match a “data_element” tag in the input documents to be styled. (See the sample input document in FIG. 4.) These “xsl:if” statements are added to incorporate the application data into the creation of the fields, via the first parameter of the “WriteField( )” invocation. Note also that the statements at 775 and 780 illustrate use of other attribute values (for the fourth parameter) and use of the color parameter (set to “GREEN”) and “REVERSE” value for highlighting.

Preferably, the “data_element” attribute at element 770 is programmatically generated based on knowledge of the schema according to which the XML documents will be created. (In preferred embodiments, a single schema is used for each application.)

Element 785 corresponds to the twelfth “POS” row of the input map, and element 790 provides the closing tag syntax for elements which were opened in element 705.

Note that the flowchart in FIG. 6 does not explicitly specify checking for each of the seven attribute values which are being passed to the “WriteField” function, or for all of the types of presentation space information that might be represented in the BMS map syntax. This is for ease of illustration, and it will be obvious how the logic in the flowchart can be extended to cover additional cases. Thus, an ellipsis (“ . . . ”) is shown in FIG. 6 following the test for attributes.

Block 655 checks to see if the last element from the BMS map file has been processed. If not, then control returns to Block 620 to continue with the next element. Otherwise, processing continues at Block 660.

Block 660 creates a lookup key that will be used for storing the generated style sheet in a style sheet repository. Preferably, this lookup key is derived from the map ID (and may be the map ID itself). Block 665 then stores the generated style sheet in the repository, using this key, and control returns to Block 600.

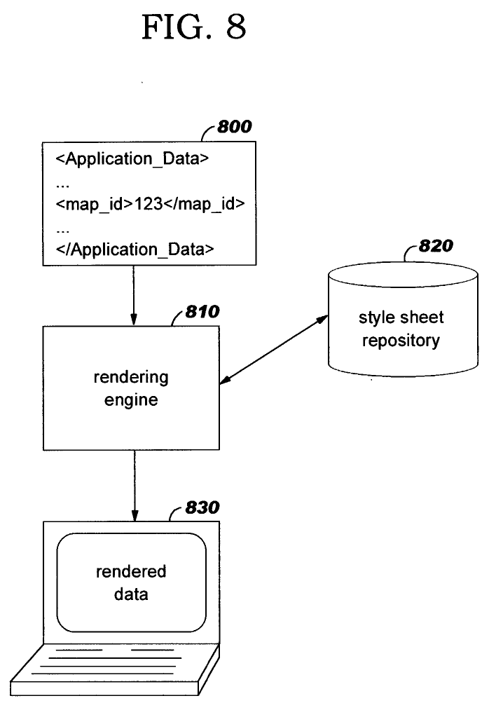

Turning now to FIG. 8, an illustration is provided showing how the generated presentation style information is fetched at run-time and applied to a collection of legacy host data values. When a particular XML document 800 is received, it is passed to a rendering engine 810. (Note that the input document is described herein as an XML document for purposes of illustration and not of limitation. Documents encoded in other markup languages or notations may be used alternatively.) Typically, this rendering engine is a browser which is adapted for processing XML documents and applying XSL style sheets to those documents. Upon locating the “map_id” value in the input document 800, the corresponding style sheet (generated according to the present invention, as discussed with reference to FIGS. 6 and 7) is retrieved from a repository 820. The data from the input document 800 is then rendered, as shown at 830, using techniques which are known in the art. This rendering comprises applying the style sheet to the data values, and providing the result on the user's device.

As stated earlier, the output from the programmatic generation techniques disclosed herein is an XSL document that may be considered as providing a “default” presentation style, and this default style may be further edited.

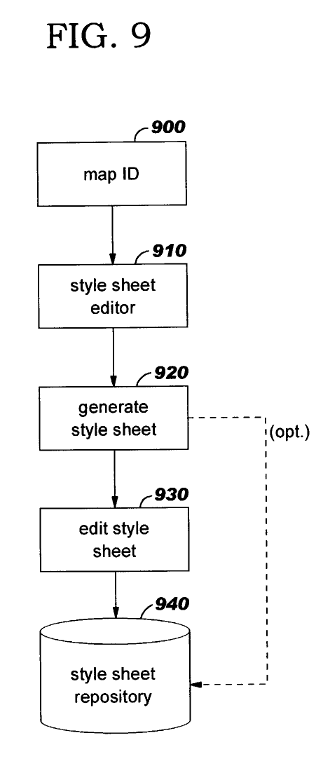

FIG. 9 illustrates how the programmatic generation techniques of the present invention may be incorporated within a style sheet editor that has been augmented to support the present invention. In this approach, a map ID 900 is supplied as input to the augmented style sheet editor 910. For example, a selection “import from BMS map” might be provided on a drop-down menu within the editor, and the map ID may be solicited from the user in response to selecting this choice. Using the supplied map ID, a style sheet 920 is programmatically generated from the corresponding BMS map (according to the techniques which have been described above). The generated style sheet 920 may then be further edited, as shown at 930, before storing the result in a stye sheet repository 940; alternatively, the generated style sheet 920 may be stored directly into the repository 940.

As an alternative to the approach shown in FIG. 9, the style sheet may be programmatically generated using a tool that is separate from the style sheet editor, and then a style sheet editor of the prior art may be used to open the generated style sheet and perform modifications thereon.

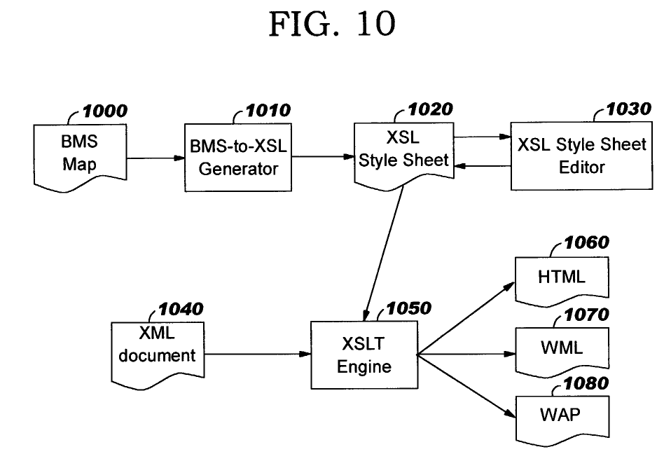

FIG. 10 depicts an overall flow of execution that may occur when using the present invention (and consolidates the processing shown in FIGS. 8 and 9). As shown in FIG. 10, a BMS map 1000 is provided as input to the programmatic generation techniques of the present invention 1010, yielding an XSL style sheet 1020. Optionally, this style sheet can be further edited using a style sheet editor 1030. At run time, an XML input document 1040 is supplied to a style sheet processor, indicated in the figure as an “XSLT” (XSL Transformations) engine 1050, which applies the style sheet 1020 to the data in the input document 1040. The result of this application of style may be one or more markup language documents as illustrated by elements 1060, 1070, 1080. In this example, an HTML document 1060, a WML document 1070, and a WAP document 1080 are shown, representing generation of different output documents for particular target devices. This may be accomplished, for example, by including conditional syntax in the generated style sheet, whereby one or more different template rules will be matched depending on factors such as the device type or user agent type from which the request document 1040 was transmitted. Techniques for detecting this type of information in an HTTP request message header are well known in the art. (Different style sheet rules might also or alternatively be created based upon factors such as the identification of the target user.) These multiple output formats illustrate how creation of a single style sheet allows for flexibly adapting the rendering of the data for multiple environments. (In addition, a sample version of an input document 1040 might be programmatically generated, in order to facilitate editing and testing of the generated style sheet. Techniques for generating the sample document do not form part of the present invention.)

It should also be noted that the programmatic style sheet generation process of the present invention allows for automated transformations of input documents for purposes other than rendering the data included therein on a GUI for a user. For example, it might be desirable to perform certain transformations for use in program-to-program exchanges within a B2B environment. The transformations can be specified in the generated style sheets, and then will be automatically applied by the style sheet engine.

As has been demonstrated, the present invention defines improvement in user interface techniques which allow users to interact with legacy host applications. Presentation style information is programmatically generated, for subsequent use when rendering (and/or transforming) a collection of data values. The generated stye sheets can be reused and/or adapted for rendering output destined for multiple devices. In the prior art, applying the style information from a BMS map would require either (1) capturing the XML output from executing a conversion program such as the 3270 bridge feature of CICS with each possible application, taking that output XML, and manually creating a style sheet to produce a desired effect when the output XML is rendered, (2) manually creating a style sheet by reading the BMS maps and copying the style information from the maps. As will be obvious, both of these prior art approaches are tedious, time consuming, and error prone. Editing the generated style sheet can be accomplished using a prior art style sheet editor, or prior art editing features of a style sheet editor which has been augmented to support generation of style sheets from BMS maps, and this editing process can be used for purposes such as introducing usability enhancements into the subsequent rendering or adapting input document for rendering on pervasive devices. Once the style sheets have been enhanced in this manner, the subsequently rendered data values may be better suited for modern computing environments. While this modification capability is optional, as has been stated, it is expected to be desirable in enterprises using the present invention since historically, many legacy host applications have very archaic screens that warrant updating to serve a newer, more generalized audience formatted for use through the web or pervasive devices. (For example, with reference to the sample display screen in FIG. 1, one might think of several ways in which to make this a more usable presentation, such as by creating a drop down list from which the user can select one of the allowed values. This drop-down list approach might be considered more usable than requiring the user to remember that “W” should be selected to invoke a browse operation. Other options include creating the choices as radio buttons.)

The present invention has been described herein primarily in terms of a 3270 presentation. However, the inventive concepts of the present invention are not limited to 3270 presentations: any presentation format may be equivalently used, where the presentation format is well-defined and has well-defined codes indicating the attribute types used in the presentation.

Furthermore, while the present invention has been described primarily in terms of generating a style sheet, alternative formats may be used. For example, the presentation style information may alternatively be generated as a collection of rules in a rule base, where a rules engine will apply the rules to an input document.

The 3270 bridge feature of CICS allows generating HTML from map source, as discussed above with reference to FIG. 2B. See “3270 Bridge” in the “Appendix: Custom Solutions” section of a white paper entitled “Web-Enabling CICS Applications, A Selection Guide”, Carol Shanesy and Leigh Compton, IBM Dallas Systems Center (15 Apr. 1999), which is published on the Internet at http://www-3.ibm.com/software/ts/cics/library/whitepapers/cicsweb/. However, the feature does not allow capturing the presentation style information from the map. (See also “Key Considerations” within section 4.2, “Solution: CICS Web Interface”, which states that the “chief disadvantage [of the 3270 bridge feature] is that the user interactions with the application are the same as they would be on a 3270. That is, you cannot put a new user interface on the application.”)

As will be appreciated by one of skill in the art, embodiments of the present invention may be provided as methods, systems, or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer-readable storage media (including, but not limited to, disk storage, CD-ROM, optical storage, and so forth) having computer-readable program code embodied therein.

The present invention has been described with reference to flow diagrams and/or block diagrams of methods, apparatus (systems), and computer program products according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

What is claimed is:

1. A method for programmatically generating a presentation style for legacy host data, comprising steps of:
identifying a mapping associated with a particular legacy host screen, where the identified mapping stores presentation style information for the particular legacy host screen;
programmatically extracting the stored presentation style information from the identified mapping;
programmatically formatting the extracted presentation style information as style information for the particular legacy host screen; and
storing the style information for the particular legacy host screen in a repository.

2. The method according to claim 1, further comprising steps of:
obtaining a set of data values for the particular legacy host screen, along with an identification of the mapping associated with the particular legacy host screen;
retrieving the stored style information from the repository using the identification of the mapping; and
programmatically creating a rendering of the particular legacy host screen by applying the retrieved style to the obtained set of data values.

3. The method according to claim 1, wherein the style information is programmatically formatted as rules in a rules base.

4. The method according to claim 1, wherein the style information is programmatically formatted as elements of a style sheet.

5. The method according to claim 4, wherein the style sheet is an Extensible Stylesheet Language (“XSL”) style sheet.

6. The method according to claim 4, wherein the style sheet is a default style sheet and further comprising the step of modifying one or more of the elements of the default style sheet.

7. The method according to claim 4, wherein the style sheet is a default style sheet and further comprising the step of adding one or more elements to the default style sheet.

8. The method according to claim 6, wherein the modified elements tailor the style sheet for a particular target device.

9. The method according to claim 7, wherein the added elements tailor the style sheet for a particular target device.

10. The method according to claim 6, wherein the modified elements tailor the style sheet for a particular recipient.

11. The method according to claim 7, wherein the added elements tailor the style sheet for a particular recipient.

12. The method according to claim 1, further comprising steps of:
obtaining a set of data values for the particular legacy host screen, along with an identification of the mapping associated with the particular legacy host screen;
retrieving the stored style information from the repository using the identification of the mapping;
programmatically creating a rendering of the particular legacy host screen by applying the retrieved style to the obtained set of data values; and
modifying one or more of the elements of the default style sheet, wherein the modified elements improve usability of the rendering.

13. The method according to claim 1, further comprising steps of:
obtaining a set of data values for the particular legacy host screen, along with an identification of the mapping associated with the particular legacy host screen;
retrieving the stored style information from the repository using the identification of the mapping;
programmatically creating a rendering of the particular legacy host screen by applying the retrieved style to the obtained set of data values; and
adding one or more of the elements of the default style sheet, wherein the added elements improve usability of the rendering.

14. A system for programmatically generating a presentation style for legacy host data, comprising:
means for identifying a mapping associated with a particular legacy host screen, where the identified mapping stores presentation style information for the particular legacy host screen;
means for programmatically extracting the stored presentation style information from the identified mapping;
means for programmatically formatting the extracted presentation style information as style information for the particular legacy host screen; and
means for storing the style information for the particular legacy host screen in a repository.

15. A computer program product for programmatically generating a presentation style for legacy host data, the computer program product embodied on one or more computer-readable media and comprising:
computer-readable program code means for identifying a mapping associated with a particular legacy host screen, where the identified mapping stores presentation style information for the particular legacy host screen;
computer-readable program code means for programmatically extracting the stored presentation style information from the identified mapping;
computer-readable program code means for programmatically formatting the extracted presentation style information as style information for the particular legacy host screen; and
computer-readable program code means for storing the style information for the particular legacy host screen in a repository.
